(19) United States
(12) Patent Application Publication
(10) Pub. No.: US 2024/0009606 A1
(43) Pub. Date: Jan. 11, 2024

(54) ELECTRETS COMPRISING A SUBSTITUTED CYCLOTRIPHOSPHAZENE COMPOUND AND ARTICLES THEREFROM

(71) Applicant: 3M INNOVATIVE PROPERTIES COMPANY, St. Paul, MN (US)

(72) Inventors: Kelly A. Volp, Minneapolis, MN (US); Nathan E. Schultz, Woodbury, MN (US); Daniel C. Duan, St. Paul, MN (US); Seth M. Kirk, Minneapolis, MN (US); Fuming B. Li, Woodbury, MN (US); John M. Sebastian, Oakdale, MN (US)

(21) Appl. No.: 18/252,199

(22) PCT Filed: Nov. 29, 2021
(86) PCT No.: PCT/IB2021/061076

§ 371 Date: May 9, 2023

Related U.S. Application Data
(60) Provisional application No. 63/127,180, filed on Dec. 18, 2020.

(51) Int. Cl. B01D 39/16; C08K 5/5399; A62B 23/02; D04H 3/007; D04H 3/16; D06B 1/02; D06M 10/02; D06M 11/05

(52) U.S. Cl. CPC B01D 39/1623; C08K 5/5399; A62B 23/025; D04H 3/007; D04H 3/16; D06B 1/02; D06M 10/025; D06M 11/05; C08K 2201/001; C08K 2201/019; B01D 2239/0435; B01D 2239/10; B01D 2239/0622; B01D 2239/0618; D06M 2101/20

(57) ABSTRACT

Described herein is the use of a cyclotriphosphazene core substituted with at least three amino-cyclic carbon groups used as a charge-enhancing additive in a thermoplastic resin. Such compositions may be used in filtering applications.

### TECHNICAL FIELD

The present disclosure relates to the use of a substituted cyclotriphosphazene compound as a charge-enhancing additive for electret webs, including non-woven fibrous webs and applications thereof.

### SUMMARY

Electrets are a dielectric material that possess a permanent or semi-permanent electric charge or dipole polarization. Electrets are useful in a variety of devices including, e.g. cling films, air filters, filtering facepieces, and respirators, and as electrostatic elements in electro-acoustic devices such as microphones, headphones, and electrostatic recorders.

The performance of microfibrous webs used for aerosol filtration can be improved by imparting an electrical charge to the fibers, forming an electret material. In particular, electrets are effective in enhancing particle capture in aerosol filters. A number of methods are known for forming electret materials in microfibrous webs. Such methods include, for example, bombarding melt-blown fibers as they issue from the die orifices, as the fibers are formed, with electrically charged particles such as electrons or ions. Other methods include, for example, charging the fibers after the web is formed, by means of a corona discharge or imparting a charge to the fiber mat by means of carding and/or needle tacking (tribocharging). In addition, a method in which jets of water or a stream of water droplets impinge on a non-woven web at a pressure sufficient to provide filtration enhancing electret charge has also been described (hydrocharging).

A variety of charge-enhancing additives have been developed for use in electret materials. U.S. Pat. No. 9,815,068 describes electret webs that include a thermoplastic resin and a charge-enhancing additive, where the charge-enhancing additive is a divalent metal-containing substituted-mercaptobenzimidazolate salt. U.S. Pat. No. 10,240,269 describes electret webs include a thermoplastic resin and a charge-enhancing additive, where the charge-enhancing additive is a fused aromatic thiourea, a fused aromatic urea compound, or a combination thereof. The change-enhancing additive may also include a hindered amine light stabilizer compound.

In one aspect, the present disclosure describes a composition comprising a substituted cyclotriphosphazene core as a charge-enhancing additive in a thermoplastic resin.

In one embodiment, the composition disclosed herein can be used in a filtering article, such as a respirator.

In another aspect, a method of making an electret is described. The method comprising: providing a composition comprising (i) a thermoplastic resin and (ii) a substituted cyclotriphosphazene core with at least three amino-cyclic carbon groups; and charging the composition via corona treatment, hydrocharging, tribocharging, or combinations thereof to form the electret.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIG. 1 is a schematic cross-sectional view of an exemplary core-sheath fiber according to the present disclosure.

FIG. 2 is a schematic perspective view of a nonwoven fibrous web according to the present disclosure.

FIG. 3 is a schematic front view of an exemplary respirator 40 according to one embodiment of the present disclosure.

FIG. 4 is a schematic cross-sectional view of mask body 42 in FIG. 3.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “comprises at least one of” A, B, and C refers to element A by itself, element B by itself, element C by itself, A and B, A and C, B and C, and a combination of all three.

The compositions of the present disclosure comprise a cyclophosphazene compound, which is used as a charge-enhancing additive in a thermoplastic resin.

The charge-enhancing additive as disclosed herein is a cyclotriphosphazene core substituted with at least three amino-cyclic carbon groups.

In one embodiment, the amino-cyclic carbon group comprises an amino group and a cycloalkyl group. The cycloalkyl group may or may not be substituted with an alkyl chain. In one embodiment, the amino-cycloalkyl group comprises, for example, 5, 6, 7, or 8 carbon atoms.

In one embodiment, the amino-cyclic carbon group comprises an amino group and an aryl group. The amino-cyclic carbon group comprising an aryl group may further comprise an ether, an amine, an alkyl group, and combinations thereof. In one embodiment, the amino-aryl group comprises, for example, 6, 7, 8, 9, 10, 11, or even 12 carbon atoms. Exemplary amino-aryl groups include a phenylamino group, an alkylphenylamino group, an alkoxyphenylamino group, a phosphor amino indane, or an alkylaminophenoxy group.

In one embodiment, the charge-enhancing additive is of formula I:

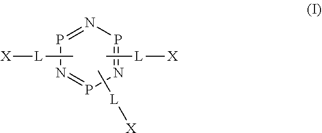

where L is selected from NH or N(R) and R is an alkyl group, optionally comprising at least 1 catenated atom selected from N (amino) or O (ether); and wherein X comprises a cyclic carbon group comprising 5-6 ring carbon atoms. As common practice, the lines intersecting the cyclotriphosphazene core are substituents that are bonded to any of the phosphorous atoms of the ring and the remainder of the phosphorous atoms are bonded to —H to satisfy the valency.

In one embodiment, the charge-enhancing additive is of formula II:

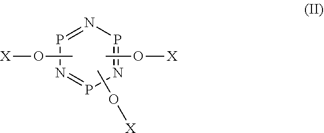

wherein X comprises a cyclic carbon group comprising an amino group and at least 5-6 carbon atoms.

In one embodiment, the charge-enhancing additive is at least one of the following:

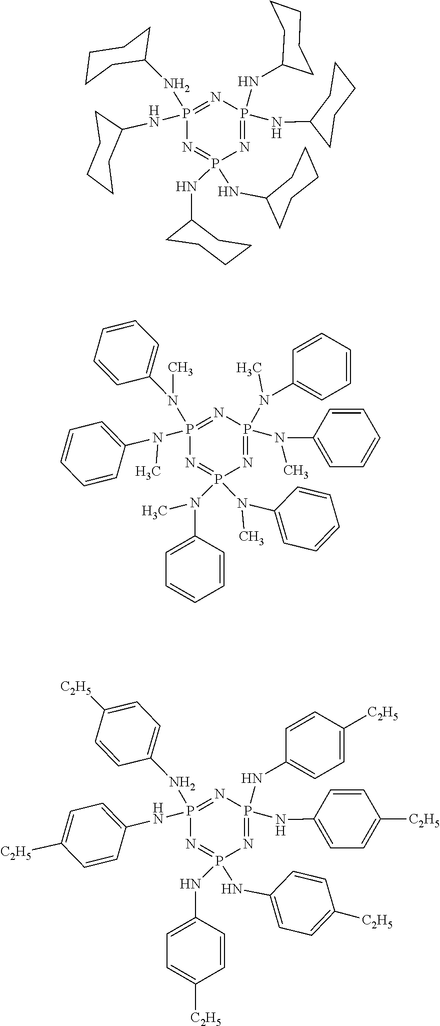

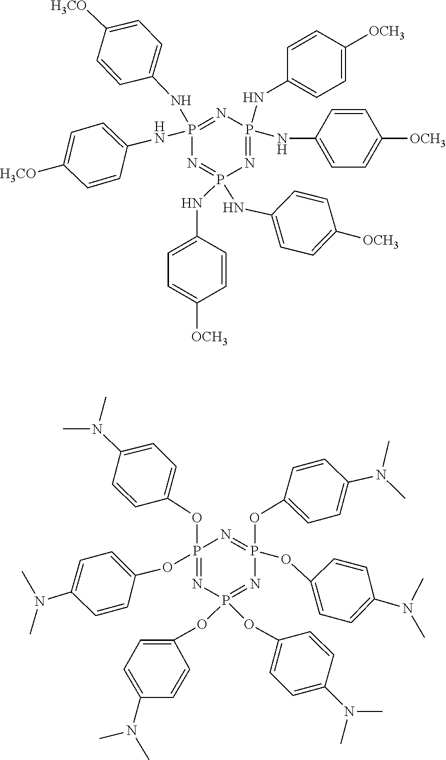

The cyclotriphosphazene core substituted with at least three amino-cyclic carbon groups may be commercially available or can be synthesized, for example, by substituting a 1,3,5,2,4,6-triazatriphosphorine-2,2,4,4,6,6-hexachloride with a phenol or aryl amine as shown in the Example Section below. Generally, the amino-cyclic carbon groups substituted on the cyclotriphosphazene core are identical due to the synthesis.

The cyclotriphosphazene core substituted with at least three amino-cyclic carbon groups disclosed herein can be used as a charge enhancing additive. Charge enhancing additives are materials that increase the Quality Factor (QF) discussed below.

Preferably, the cyclotriphosphazene core substituted with at least three amino-cyclic carbon groups used as a charge enhancing additive is a solid at ambient conditions to prevent migration within the resin and does not decompose at moderate temperatures (such as processing temperatures). In one embodiment, the charge enhancing additive is a solid at temperatures of at least 25, 30, 40, 50, 60, 80 or even 100° C. In one embodiment, the charge enhancing additive does not decompose. For example, there is no significant weight loss (i.e., loss less than 5, 1, or even 0.1 wt %) when measured under nitrogen by thermogravimetric analysis using a ramp rate of 10° C./min when heated up to 220° C., 235° C., or even 250° C.

The cyclotriphosphazene core substituted with at least three amino-cyclic carbon groups disclosed herein should not covalently bond with the thermoplastic resin, but are instead blended in a thermoplastic resin. The cyclotriphosphazene core substituted with at least three amino-cyclic carbon groups of this disclosure may be effective as a charge enhancing additive in relatively small quantities. Typically, the cyclotriphosphazene core substituted with at least three amino-cyclic carbon groups is present in a thermoplastic resin in amounts of up to about 10% by weight, more typically in the range of 0.01 to 5% by weight based upon the total weight of the blend. In some embodiments, the cyclotriphosphazene core substituted with at least three amino-cyclic carbon groups is present in the electret composition in an amount ranging from 0.1 to 3% by weight, 0.1 to 2% by weight, 0.2 to 1.0% by weight, or 0.25 to 0.5% by weight.

Typically, the cyclotriphosphazene core substituted with at least three amino-cyclic carbon groups disclosed herein is blended with a thermoplastic resin and made into fibers.

Thermoplastic resins useful in the present disclosure include any thermoplastic nonconductive polymer capable of retaining a high quantity of trapped electrostatic charge when formed into a web and charged. Typically, such polymeric resins have a DC (direct current) resistivity of greater than 10¹⁴ ohm-cm at the temperature of intended use. Polymers capable of acquiring a trapped charge include polyolefins such as polypropylene, polyethylene (e.g., HDPE, LDPE, LLDPE, VLDPE; ULDPE, UHMW-PE grades), poly(1-butene), poly(3-methylbutene), poly(4-methyl-1-pentene); polyvinyl chloride; polystyrene; polycarbonates; polyesters, including polylactides; and perfluorinated polymers and copolymers. Preferably, the thermoplastic resin comprises polypropylene.

Examples of suitable thermoplastic resins include, for example, the polypropylene resins: ESCORENE PP 3746G commercially available from Exxon-Mobil Corporation, Irving, TX; TOTAL PP3960, TOTAL PP3860, and TOTAL PP3868 commercially available from Total Petrochemicals USA Inc., Houston, TX; and METOCENE MF 650W commercially available from LyondellBasell Industries, Inc., Rotterdam, Netherlands; and the poly-4-methyl-1-pentene resin TPX-DX820, TPX-DX470, and TPX-MX002 commercially available from Mitsui Chemicals, Inc., Tokyo, Japan.

Blends of the thermoplastic resin and the charge-enhancing additive can be prepared by well-known methods. Typically, the blend of the charge-enhancing additive and a thermoplastic resin is processed using melt extrusion techniques, so the blend may be preblended to form pellets in a batch process, or the thermoplastic resin and the charge-enhancing additive may be mixed in the extruder in a continuous process. Where a continuous process is used, the thermoplastic resin and the charge-enhancing additive may be pre-mixed as solids or added separately to the extruder and allowed to mix in the molten state.

Examples of melt mixers that may be used to form preblended pellets include those that provide dispersive mixing, distributive mixing, or a combination of dispersive and distributive mixing. Examples of batch methods include those using a BRABENDER (e. g. a BRABENDER PREP CENTER, commercially available from C. W. Brabender Instruments, Inc.; South Hackensack, New Jersey) or BANBURY internal mixing and roll milling equipment (e.g. equipment available from Farrel Co.; Ansonia, Connecticut). After batch mixing, the mixture created may be immediately quenched and stored below the melting temperature of the mixture for later processing.

Examples of continuous methods include single screw extruding, twin screw extruding, disk extruding, reciprocating single screw extruding, and pin barrel single screw extruding. The continuous methods can include utilizing both distributive elements, such as cavity transfer mixers (e.g. CTM, commercially available from RAPRA Technology, Ltd.; Shrewsbury, England) and pin mixing elements, static mixing elements or dispersive mixing elements (commercially available from e.g., MADDOCK mixing elements or SAXTON mixing elements).

Examples of extruders that may be used to extrude preblended pellets prepared by a batch process include the same types of equipment described above for continuous processing. Useful extrusion conditions are generally those which are suitable for extruding the resin without the additive.

In one embodiment, the resin comprising the charge-enhancing additive is a fiber. The fiber may have any cross-sectional shape, for example, triangular, square, rectangular, pentagonal, hexagonal, heptagonal, octagonal, star-shaped, oval, trilobal, and tetralobal.

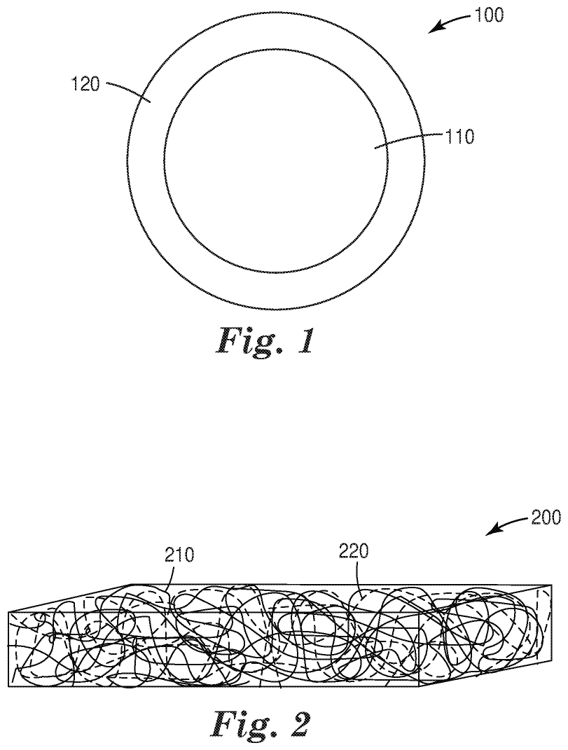

In one embodiment, the fiber is a fiber core encapsulated with a sheath, a so-called sheath-core fiber as shown in FIG. 1. In FIG. 1, sheath-core fiber 100 comprises a core 110 having a sheath layer 120 disposed thereon. While not shown, the sheath layer 120 is coextensive along the fiber length (fiber ends excluded). The core may have any average diameter, but preferably is in a range of from 1 to 100 microns, more preferable 5 to 50 microns, and even more preferably 10 to microns. In one embodiment, the sheath layer may be thin for example having a thickness of at least 0.05, 0.1, 0.2, 0.4, 0.5, or even 0.6 microns; and at most 0.8, 1.0, 1.5, 2.0, 2.5, 2.8, or even 3.0 microns in average thickness.

In one embodiment, the composition may comprise a second charge enhancing additive, besides the substituted cyclotriphosphazene core disclosed herein. Such second charge enhancing additives are known in the art and include hindered amine light stabilizer additives, triazine-based additives, and hindered phenol-based additives.

Specific examples of the hindered amine-based or triazine-based additives include (poly[[6-(1,1,3,3,-tetramethylbutyl) amino]-s-tearine-2,4-diyl][[(2,2,6,6-tetramethyl-4-piperidyl) imino]hexamethylene [(2,2,6, 6-tetramethyl-4-piperidyl) imino]]), available under the trade designation “CHIMASSORB 944” from BASF, Ludwigshafen, Germany; dimethyl succinate-1-(2-hydroxyethyl)-4-hydroxy-2,2,6,6-tetramethylpiperidine polycondensate, available under the trade designation “TINUVIN 622” from BASF; di-tert-butyl-4-hydroxybenzyl)-2-n-butyl malonate bis(1,2,2,6,6-pentamethyl-4-piperidyl available under the trade designation “TINUVIN 144” from BASF; a polycondensate of dibutylamine-1,3,5-triazine-N,N-bis(2,2,6,6-tetramethyl-4-piperidyl-1,6-hexamethylenediamine-N-(2,2,6,6-tetramethyl-4-piperidyl)butylamine, available under the trade designation “CHIMASSORB 2020” from BASF; 2-(4,6-diphenyl-1,3,5-triazin-2-yl)-5-((hexyl)oxy)-phenol, available under the trade designation “TINUVIN 1577” from BASF; N-substituted amino aromatic compounds, particularly tri-amino substituted compounds, such as 2,4,6-trianilino-p-(carbo-2′-ethylhexyl-1′-oxy)-1,3,5-triazine, available under the trade designation “UVINUL T450” from BASF; and 24,6-tris-(ortadecylamino)triazine, also known as tristearyl melamine (“TSM”).

Hindered phenol-based additives having a hydroxyl group as the terminal functional group. The hindered phenol-based additives are not particularly limited, and specific examples include pentaerythrityl-tetrakis[3-(3,5-di-tert-butyl-4-hydroxyphenyl)propionate] (Irganox 1010, manufactured by BASF), octadecyl-3-(3,5-di-tert-butyl-4-hydroxyphenyl) propionate (Irganox 1076, manufactured by BASF), tris-(3,5-di-tert-butyl-4-hydroxybenzyl)-isocyanurate (Irganox 3114, Manufactured by BASF), 3,9-bis-{2-[3-(3-tert-butyl-4-hydroxy-5-methylphenyl)-propionyloxy]-1,1-dimethylethyl}-2,4,8,10-tetraoxaspiro-[5,5]undecane (Sumilizer-GA-80, manufactured by Sumitomo Chemical Co., Ltd.), and the like.

Triazine-based charge enhancing additives include thermally stable organic triazine compounds or oligomers, which contain at least one nitrogen atom in addition to those in the triazine ring, are disclosed in U.S. Pat. Nos. 6,268,495, 5,976,208, 5,968,635, 5,919,847, and 5,908,598 to Rousseau et al.

Further examples of charge-enhancing additives are provided in U. S. Pat. Publ. No. 2011/0137082 (Li et al.). U.S. Pat. Nos. 8,613,795 (Li et al.), 7,390,351 (Leir et al.), 5,057,710 (Nishiura et al.), and 4,652,282 and 4,789,504, both to Susumu et al., and U.S. Pat. No. 8,790,449 B2 (Li et al.).

Generally, charge enhancing additives do not include hindered amine compounds comprising an ether linked group attached to a nitrogen atom in a N—O—R type configuration, typically referred to as NOR-HALS. Exemplary NOR-HALS are disclosed in U.S. Pat. No. 7,947,767 (Chin et al.), herein incorporated by reference. Exemplary commercially available NOR-HALS include a hindered amine NOR stabilizer available under the trade designation “TINUVIN NOR 371” from BASF. In one embodiment, the composition is substantially free (i.e., comprises less than 0.05, or even 0.01 wt %, or even none) NOR-HAL.

In one embodiment, the composition may comprise one or more conventional adjuvants such as antioxidants, light stabilizers, plasticizers, acid neutralizers, fillers, antimicrobials, surfactants, antiblocking agents, pigments, primers, dispersants, and other adhesion promoting agents. It may be particularly beneficial for medical applications to incorporate the antimicrobials and enhancers discussed in U.S. Pat. No. 7,879,746 (Klun et al.), incorporated herein by reference. It may be particularly beneficial for certain applications to incorporate surfactants discussed in U. S. Pat. Appl. Publ. No. 2012/0077886 (Scholz et al.), incorporated herein by reference.

In one embodiment, an additive compound may be added to the resin to alter the surface characteristics of the fiber, such as dirt or oil repellency. For example, fluorinating the fiber. In one embodiment a fluorinated compound (such as fluorinated compounds available as Repellent Polymer Melt Additive PM-870, from 3M Co., Maplewood, MN) may be added to the polymeric resin. In another embodiment, the fiber can be placed in an atmosphere that contains a fluorine-containing species and an inert gas and then applying an electrical discharge to modify the surface chemistry of the fiber. The electrical discharge may be in the form of a plasma such as an AC corona discharge. This plasma fluorination process causes fluorine atoms to become present on the surface of the polymeric article. The plasma fluorination process is described in a number of U.S. Pat. Nos. 6,397,458, 6,398,847, 6,409,806, 6,432,175, 6,562,112, 6,660,210, and 6,808,551 to Jones/Lyons et al. Electret articles that have a high fluorosaturation ratio are described in U.S. Pat. No. 7,244,291 to Spartz et al., and electret articles that have a low fluorosaturation ratio, in conjunction with heteroatoms, is described in U.S. Pat. No. 7,244,292 to Kirk et al. Other publications that disclose fluorination techniques include: U.S. Pat. Nos. 6,419,871, 6,238,466, 6,214,094, 6,213,122, 5,908,598, 4,557,945, 4,508,781, and 4,264,750; U.S. Pat. Publ. Nos. 2003/0134515 A1 and 2002/0174869 A1; and International Publication WO 01/07144.

Generally, the fibers disclosed herein are free of a fiber finish. Fiber finishes are treatments used to alter the surface properties of the fiber to enable easier/improved processing of the fiber. In one embodiment, the fibers of the present disclosure are substantially free (comprises less than 30, 20, 10, 5, 1, 0.5, or even 0.1 wt %) of a sorbitan fatty acid ester or polyoxyalkylene alkyl ester.

Fibers used in practice of the present disclosure may have any average fiber diameter, and may be continuous, random, and/or staple fibers. For example, in some embodiments, the fibers (i.e., individual fibers) may have an average fiber diameter of at least 5, 6, 8, or even 10 microns; and at most 15, 18, 20, 22, or even 25 microns.

In one embodiment, the diameter of the fiber can be determined by microscopy (e.g., optical or scanning electron microscopy), wherein the fiber is cross-sectioned and viewed under magnification to determine the diameter of the fiber.

In one embodiment, the diameter of the fiber can be calculated by a measuring the pressure drop across a fiber web. The effective fiber diameter (EFD) can be calculated as set forth in C. N. Davies, The Separation of Airborne Dust and Particulates, Institution of Mechanical Engineers, London Proceedings, IB (1952). In practice, the fiber thickness may show some experimental variation as a result of routine experimental variation and the averaging nature of EFD.

Fibers (filaments) described herein can generally be made using techniques known in the art for making filaments. Such techniques include wet spinning, dry spinning, melt spinning, melt blowing, or gel spinning.

Particularly advantageous is melt spinning. In melt spinning, a polymer is heated, passed through a spinneret, and fibers solidify upon cooling. For example, a melt spinning process can occur to collect the multicomponent filaments. The term “meltspun” as used herein refers to filaments that are formed by extruding molten filaments out of a set of orifices and allowing the filaments to cool and (at least partially) solidify to form filaments, with the filaments passing through an air space (which may contain streams of moving air) to assist in cooling and solidifying the filaments, and with the thus-formed fibers then passing through an attenuation (i.e., drawing) unit to draw the fibers.

Melt spinning can be distinguished from melt blowing, which involves the extrusion of molten filaments into converging high velocity air streams introduced by way of air-blowing orifices located in close proximity to the extrusion orifices. Melt spinning can also be distinguished from electrospinning in that electrospinning could be described as extruding out of a need a solvent solution. A modification of the spinneret results in multicomponent (e.g., core-sheath) fibers (See, e.g., U.S. Pat. Nos. 4,406,850 (Hills), 5,458,972 (Hagen), 5,411,693 (Wust), 5,618,479 (Lijten), and 5,989,004 (Cook)). Filaments according to the present disclosure can also be made by fibrillation of a film, which may provide filaments having a rectangular cross-section.

Referring now to FIG. 2, exemplary nonwoven fibrous web 200 comprises fibers 210 and optional secondary fibers 220. Fibers 210 have an average fiber diameter of 2 to 100 microns and comprise a substituted cyclotriphosphazene compound according to the present disclosure. Optional secondary fibers may be any fiber type and/or have any average fiber diameter.

Nonwoven fibrous webs may be made, for example, by conventional air laid, carded, stitch bonded, spunbonded, wet laid, air laid, and/or meltblown procedures.

Spunbonded nonwoven fibrous webs can be formed according to well-known conventional methods wherein meltspun fibers are deposited on a moving belt where they form a nonwoven continuous fiber web having interfiber bonds. Meltblown nonwoven fibrous webs are made by a similar process except that high velocity gas impinges on the extruded fibers thereby stretching and thinning them before they are collected on a rotating drum. Meltblown fiber webs likewise have interfiber bonds, although the webs generally do not have the cohesive strength of corresponding spunbonded fiber webs.

In some embodiments, a nonwoven web can be made by air-laying of fibers. Air-laid nonwoven fibrous webs may be prepared using equipment such as, for example, that available as a RANDO WEBBER from Rando Machine Company of Macedon, New York. In some embodiments, a type of air-laying may be used that is termed gravity-laying, as described, e.g., in U. S. Pat. Application Publication 2011/0247839 to Lalouch, the disclosure of which is incorporated by reference herein. Nonwoven fibrous webs may be densified and strengthened, for example, by techniques such as crosslapping, stitchbonding, needletacking, hydroentangling, chemical bonding, and/or thermal bonding. In other embodiments, the nonwoven web is not an air-laid fiber web.

Nonwoven fibrous webs according to the present disclosure may have any basis weight, thickness, porosity, and/or density unless otherwise specified. In some embodiments, the nonwoven fibrous webs are lofty open nonwoven fibrous webs. In some embodiments, fibers of the nonwoven fibrous web have an effective fiber diameter of from at least 3, 4, 5, 10, 15, 20, or micrometers and at most 125, 100, 90, 80, 75, 50, 40, or even 30 micrometers.

In one embodiment, the web contains a distribution of fiber lengths. In one embodiment, the distribution contains long fiber stands. For example, fibers having a length greater than 40, 60, 100, 500, or even 1000 millimeters. These long fiber strands can theoretically be infinite in length, but are typically less than 2000 or even 1000 meters in length.

Fibers of the present disclosure and/or nonwoven fibrous webs containing fibers of the present disclosure may be charged as it is formed, or charged after it is formed. For electret filter media (e.g., a nonwoven fibrous web), the media is generally charged after the fiber web is formed.

In general, any standard charging method known in the art may be used. For example, charging may be carried out in a variety of ways, including tribocharging, hydrocharging, and corona discharge. A combination of methods may also be used. As mentioned above, in some embodiments, the electret webs of this disclosure have the desirable feature of being capable of being charged by corona discharge alone, particularly DC corona discharge, without the need of additional charging methods. Examples of suitable corona discharge processes are described in U. S. Pat. Re. No. 30,782 (van Turnhout), U. S. Pat. Re. No. 31,285 (van Turnhout), U. S. Pat. Re. No. 32,171 (van Turnhout), U.S. Pat. No. 4,215,682 (Davis et al.), U.S. Pat. No. 4,375,718 (Wadsworth et al.), U.S. Pat. No. 5,401,446 (Wadsworth et al.), U.S. Pat. No. 4,588,537 (Klaase et al.), U.S. Pat. No. 4,592,815 (Nakao), U.S. Pat. No. 6,365,088 (Knight et al.), British Pat. 384,052 (Hansen), U.S. Pat. No. 5,643,525 (McGinty et al.), Japanese Pat. No. 4,141,679 B2 (Kawabe et al.). Further methods are discussed by M. Paajanen et. al. in Journal of Physics D: Applied Physics (2001), vol. 34, pp. 2482-2488, and by G. M. Sessler and J. E. West in Journal of Electrostatics (1975), 1, pp. 111-123.

Another technique that can be used to charge the electret web is hydrocharging. Hydrocharging of the web is carried out by contacting the fibers with water in a manner sufficient to impart a charge to the fibers, followed by drying of the web. One example of hydrocharging involves impinging jets of water or a stream of water droplets onto the web at a pressure sufficient to provide the web with filtration enhancing electret charge, and then drying the web. The pressure necessary to achieve optimum results varies depending on the type of sprayer used, the type of polymer from which the web is formed, the type and concentration of additives to the polymer, the thickness and density of the web and whether pre-treatment, such as corona surface treatment, was carried out prior to hydrocharging. Generally, water pressures in the range of about 10 to 500 psi (69 to 3450 kPa) are suitable. The jets of water or stream of water droplets can be provided by any suitable spray device. One example of a useful spray device is the apparatus used for hydraulically entangling fibers. An example of a suitable method of hydrocharging is described in U.S. Pat. No. 5,496,507 (Angadjivand et al.). Other methods are described in U.S. Pat. Nos. 6,824,718 (Eitzman et al.), 6,743,464 (Insley et al.), 6,454,986 (Eitzman et al.), 6,406,657 (Eitzman et al.), and 6,375,886 (Angadjivand et al.). The hydrocharging of the web may also be carried out using the method disclosed in the U.S. Pat. No. 7,765,698 (Sebastian et al.).

It has been surprisingly discovered that compositions comprising the cyclotriphosphazene core substituted with at least three amino-cyclic carbon groups can have an electret charge. An electret charge means that there is at least quasi-permanent electrical charge, where “quasi-permanent’ means that the electric charge is present under standard atmospheric conditions (22° C., 101,300 Pascals atmospheric pressure, and 50% relative humidity) for a time period long enough to be significantly measurable. Electric charge may be characterized by the X-ray Discharge Test as described in U.S. Pat. No. 9,815,067 (Schultz et al.) in col. 18, lines 12-42, incorporated herein by reference. Unlike an electrostatic charge that dissipates shortly thereafter (such as can be created as a result of friction), the electret charge of the (e.g., nonwoven) web articles is a quasi-permanent electric charge that is substantially maintained for the intended product life of the article. Hence, sufficient charge is evident at the time of use as well as at least 6 months or 12 months after manufacturing.

To verify that a particular filter medium is electrostatically charged in nature, one may examine its performance after exposure to ionizing x-ray radiation. As described in the literature (Air Filtration by B. C. Brown (Pergamon Press, 1993 and “Application of Cavity Theory to the Discharge of Electrostatic Dust Filters by x-Rays”, A. J. WAKER and R. C. BROWN, Applied Radiation and Isotopes, Vol. 39, No. 7, pp. 677-684, 1988), if an electrostatically charged filter is exposed to x-rays, the penetration of an aerosol through the filter will be greater after exposure than before exposure, because the ions produced by the x-rays in the gas cavities between the fibers will have neutralized some of the electric charge. Thus, a plot of penetration against cumulative x-ray exposure can be obtained which shows a steady increase up to a constant level after which further irradiation causes no change. At this point all of the charge has been removed from the filter. In some embodiments, the electret charge of a (e.g., unitary) fiber web may be characterized by exhibiting, a penetration ratio of at least 50%.

In one embodiment, the compositions comprising the cyclotriphosphazene core substituted with at least three amino-cyclic carbon groups of the present disclosure are not flame retardant. As used herein, “flame retardant” means that the compositions are more burn resistant than identical compositions made without the cyclotriphosphazene core substituted with at least three amino-cyclic carbon groups disclosed herein. A number of tests are known for determining the flame retardancy of materials. For example, the Oxygen Index, ASTM D-635 (horizontal) and U.L. 94 Tests are frequently used to evaluate flammability characteristics of polymers. Any one of these tests may be used to determine the (lack of) flame retardancy of the present composition.

Fibers according to the present disclosure are useful, for example, in the manufacture of nonwoven filter media, and especially nonwoven electret filter media.

In one embodiment, the fibers of the present disclosure may be included in a filtering article, including: an air filter element of a respirator, such as a filtering facepiece, or for such purposes as home and industrial air-conditioners, air cleaners, vacuum cleaners, medical air line filters, and air conditioning systems for vehicles and common equipment, such as computers, computer disk drives and electronic equipment. In some embodiments, the filtering article is combined with a respirator assembly to form a respiratory device designed to be used by a person. In respirator uses, the filtering articles may be in the form of molded, pleated, or folded half-face respirators, replaceable cartridges or canisters, or prefilters. As used herein, the term “respirator” means a system or device worn over a person's breathing passages to prevent contaminants from entering the wearer's respiratory tract and/or protect other persons or things from exposure to pathogens or other contaminants expelled by the wearer during respiration, including, but not limited to filtering face masks.

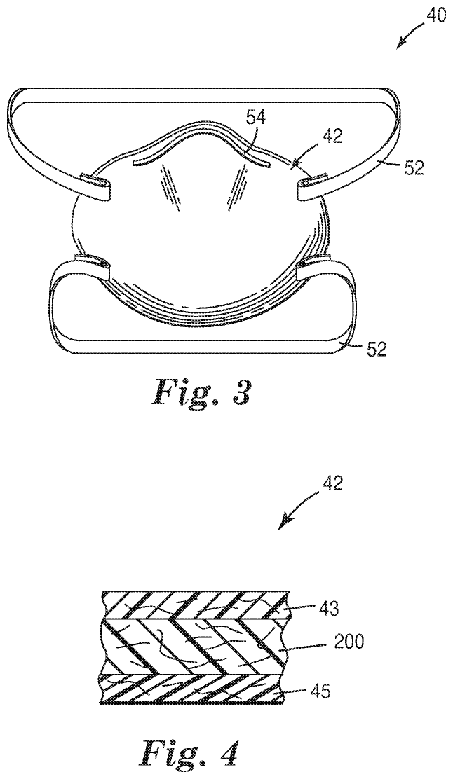

Shown in FIGS. 3 and 4 is one example of a respirator. Respirator 40 comprises mask body 42 which can be of curved, hemispherical shape or may take on other shapes as desired (e.g., see U.S. Pat. No. 5,307,796 (Kronzer et al.) and 4,827,924 (Japuntich)). In mask 40, electret nonwoven fibrous web (i.e., filter media) 200 according to the present disclosure is sandwiched between cover web 43 and inner shaping layer 45. Shaping layer 45 provides structure to the mask body 42 and support for filter media 200.

Shaping layer 45 may be located on either side of the filter media 200 and can be made, for example, from a nonwoven web of thermally-bondable fibers molded into a cup-shaped configuration. The shaping layer can be molded in accordance with known procedures (e.g., see U.S. Pat. No. 5,307,796 (Kronzer et al.), the disclosure of which is incorporated herein by reference. The shaping layer or layers typically are made of bicomponent fibers that have a core of a high melting materials such as polyethylene terephthalate, surrounded by a sheath of lower melting material so that when heated in a mold, the shaping layer conforms to the shape of the mold and retains this shape when cooled to room temperature. When pressed together with another layer, such as the filter layer, the low melting sheath material can also serve to bond the layers together.

To hold the mask 40 snugly on the wearer's face, masks body 42 can have straps 52, tie strings, a mask harness, etc. attached thereto. A pliable soft band 54 of metal, such as aluminum, can be provided on mask body 42 to allow it to be shaped to hold the mask 40 in a desired fitting relationship on the nose of the wearer (e.g., see U.S. Pat. No. 5,558,089 (Castiglione et al.)). Respirators according to the present disclosure may also include additional layers, valves (e.g., see U.S. Pat. No. 5,509,436 (Japuntich et al.), molded face pieces, etc. Examples of respirators that can incorporate the electret filter media according to the present disclosure include those described in U.S. Pat. No. 4,536,440 (Berg), 4,827,924 (Japuntich), 5,325,892 (Japuntich et al.), 4,807,619 (Dyrud et al.), 4,886,058 (Brostrom et al.), and RE35,062 (Brostrom et al.).

To assess filtration performance, a variety of filtration testing protocols have been developed. These tests include measurement of the aerosol penetration of the filter web using a standard challenge aerosol such as dioctylphthalate (DOP), which is usually presented as percent of aerosol penetration through the filter web (% Pen) and measurement of the pressure drop across the filter web (ΔP). From these two measurements, a quantity known as the Quality Factor (QF) may be calculated by the following equation:

QF=−ln(%Pen/100)/ΔP,

where In stands for the natural logarithm. A higher QF value indicates better filtration performance, and decreased QF values effectively correlate with decreased filtration performance. Details for measuring these values are presented in the Examples section. Typically, the filtration media of this disclosure have measured QF values of 0.3 (mm of H₂O)⁻¹ or greater at a face velocity of 13.8 centimeters per second (cm/s) or 6.9 cm/s.

The initial Quality Factor (Q0) is typically at least 0.2 and preferably at least 0.3, 0.4 or even 0.5 for a face velocity of 13.8 cm/s or 6.9 cm/s. when tested according to the Filtration. Performance Test Method; as described in the forthcoming examples. More preferably, the initial Quality Factor is at least 0.6 or 0.7. In some embodiments, the initial Quality Factor is at least 0.8, at least 0.90, at least 1.0, or even greater than 1.0. To test the performance of the filter web, the filter web is challenged with x-rays at room temperature (e.g., 23° C.) for a specified time and the Quality Factor is measured again. In one embodiment, the Quality Factor after 40 minutes exposure to x-rays is typically at least 50% less than the initial Quality Factor.

In order for the web to have sufficient charge for use as a filter, the % Penetration Ratio is typically at least 50%. As the % Penetration Ratio increase, the filtration performance of the web also increases, in some embodiments, the % Penetration Ratio is at least 55%, 60%, or 70%. In preferred embodiments, the % Penetration Ratio is at least 75% or 80%. In some embodiments, the unitary web exhibits a % Penetration Ratio of at least 85%, at least, or at least 95%.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

TABLE 1
Materials List

| DESIGNATION | Description |
|---|---|
| PP-1 | Polypropylene, 650 W, commercially available from |
| | LyondellBasell Industries, Houston, TX |
| PP-2 | Polypropylene, 650 X, commercially available from |
| | LyondellBasell Industries, Houston, TX |
| hexachlorocyclotriphosphazene | available from Sigma Aldrich, St. Louis, MO |
| triethylamine | Base, available from EMD Millipore Corp. Burlington, MA |
| 4-ethylaniline | available from Aldrich Chemistry, St. Louis, MO |
| para-anisidine | available from Alfa Aesar, Haverhill, MA |
| Toluene (dry) | available from Alfa Aesar, Haverhill, MA |
| methanol | available from EMD Millipore Corp. Burlington, MA |
| Ethyl acetate (EtOAc) | available from VWR Chemicals, Radnor PA |
| Dioxane (dry) | available from Alfa Aesar, Haverhill, MA |
| Compound 1 | 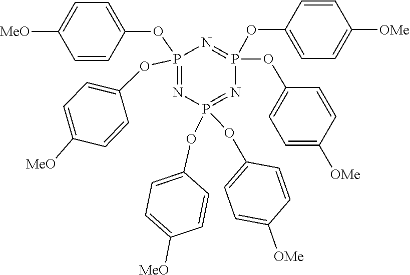 [SMILES: COc1ccc(OP2(Oc3ccc(OC)cc3)=NP(Oc3ccc(OC)cc3)(Oc3ccc(OC)cc3)=NP(Oc3ccc(OC)cc3)(Oc3ccc(OC)cc3)=N2)cc1] |
| | where Me is methyl, prepared as described for structure lf |
| | in U.S. Pat. No. 5,639,808 (Coggio, et al.) |
| Compound 2 | 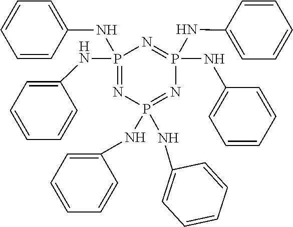 [SMILES: c1ccc(NP2(Nc3ccccc3)=NP(Nc3ccccc3)(Nc3ccccc3)=NP(Nc3ccccc3)(Nc3ccccc3)=N2)cc1] |
| | purchased from Sigma |
| | AldrichCPR |
| Compound 3 | 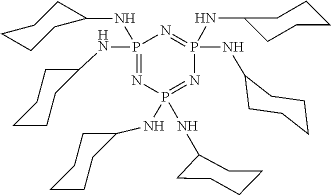 [SMILES: C1CCC(NP2(NC3CCCCC3)=NP(NC3CCCCC3)(NC3CCCCC3)=NP(NC3CCCCC3)(NC3CCCCC3)=N2)CC1] |
| | purchased from |
| | Sigma AldrichCPR |
| Compound 4 | 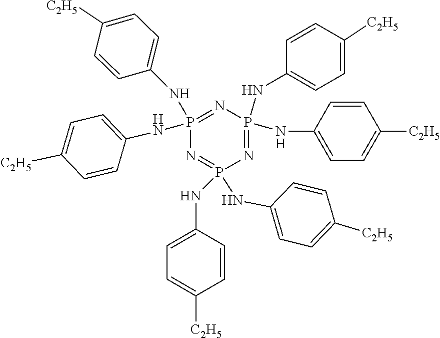 [SMILES: CCc1ccc(NP2(Nc3ccc(CC)cc3)=NP(Nc3ccc(CC)cc3)(Nc3ccc(CC)cc3)=NP(Nc3ccc(CC)cc3)(Nc3ccc(CC)cc3)=N2)cc1] |
| | See preparation below |
| Compound 5 | 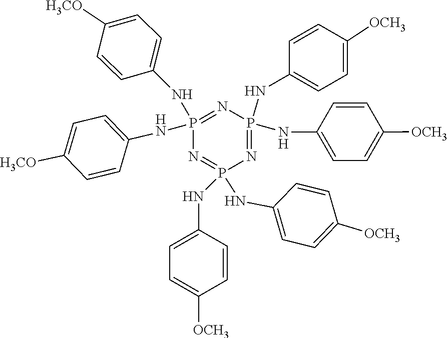 [SMILES: COc1ccc(NP2(Nc3ccc(OC)cc3)=NP(Nc3ccc(OC)cc3)(Nc3ccc(OC)cc3)=NP(Nc3ccc(OC)cc3)(Nc3ccc(OC)cc3)=N2)cc1] |
| | See preparation below |
| Compound 6 | 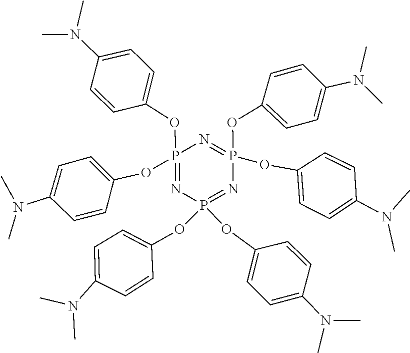 |
| | See preparation below |

Test Method

Thermal Gravimetric Analysis (TGA)

The thermal stability of select phosphazenes was measured by thermogravimetric analysis (TGA) (model Q500 by TA Instruments, New Castle, DE). Approximately 5 milligrams (mg) of a dried sample was heated under nitrogen from a starting temperature of around 35° C. to 450° C. at a rate of 10° C./minute. The sample was weighed and the temperature where 5% and 10% weight loss occurred is reported in Table 3.

Filtration Performance Test Method

The samples were tested for % aerosol penetration (% Pen) and pressure drop (ΔP), and the quality factor (QF) was calculated from these two values. The filtration performance (% Pen and QF) of the nonwoven microfiber webs were evaluated using an Automated Filter Tester AFT Model 8130 (available from TSI, Inc., St. Paul, MN) using dioctylphthalate (DOP) as the challenge aerosol and a pressure transducer that measured pressure drop (AP (mm of H₂O)) across the filter. The DOP aerosol was nominally a monodisperse 0.33 micrometer mass median diameter (MMD) having an upstream concentration of 50-200 mg/m³ and a target of 100 mg/m³. The aerosol was forced through a sample of filter media at a calibrated flow rate of 85 or 42.5 lpm (liters/minute) (face velocity of 13.8 cm/s or 6.9 cm/s as noted in the examples below). The aerosol ionizer was turned off for these tests. The total testing time was 23 seconds (rise time of 15 seconds, sample time of 4 seconds, and purge time of 4 seconds). The concentration of DOP aerosols was measured by light scattering both upstream and downstream of the filter media using calibrated photometers. The DOP % Pen is defined as: % Pen=100×(DOP concentration downstream/DOP concentration upstream). For each material, 6 separate measurements were made at different locations on the web and the results were averaged to determine the QF value.

Fiber and Non-Woven Sample Preparation

Step A—Fiber and Web Formation:

For each sample, the filtration media was formed by first dry blending the substituted cyclotriphosphazene compound indicated in Tables 4-5 with the indicated polypropylene resin (PP-1 or PP-2) and made into a melt blown fiber web. The extrusion temperature was 250° C. and the web properties were as follows: basis weight of 65 g/m², solidity of 5.5%, and effective fiber diameter of 8 microns.

Step B—Electret Preparation:

Each of the meltblown webs was charged by one of two electret charging methods: corona charging or hydrocharging. The methods are designated as Charging Method C and H, respectively.

Charging Method C—Corona Charging:

The corona charging was accomplished by passing the web on a grounded surface under a corona brush source with a corona current of about 0.01 milliamp per centimeter of discharge source length at a rate of about 3 centimeters per second. The corona source was about 3.5 centimeters above the grounded surface on which the web was carried. The corona source was driven by a positive DC voltage.

Charging Method H—Hydrocharging:

A fine spray of high purity water having a conductivity of less than 5 microSiemens/cm was continuously generated from a nozzle operating at a pressure of 896 kiloPascals (130 psig) and a flow rate of approximately 1.4 liters/minute. Selected webs prepared in Step A were conveyed by a porous belt through the water spray at a speed of approximately 10 centimeters/second while a vacuum simultaneously drew the water through the web from below. Each web was run through the hydrocharger twice (sequentially once on each side) and then allowed to dry completely overnight prior to filter testing.

Synthesis of Selected Cyclotriphosphazene Compounds

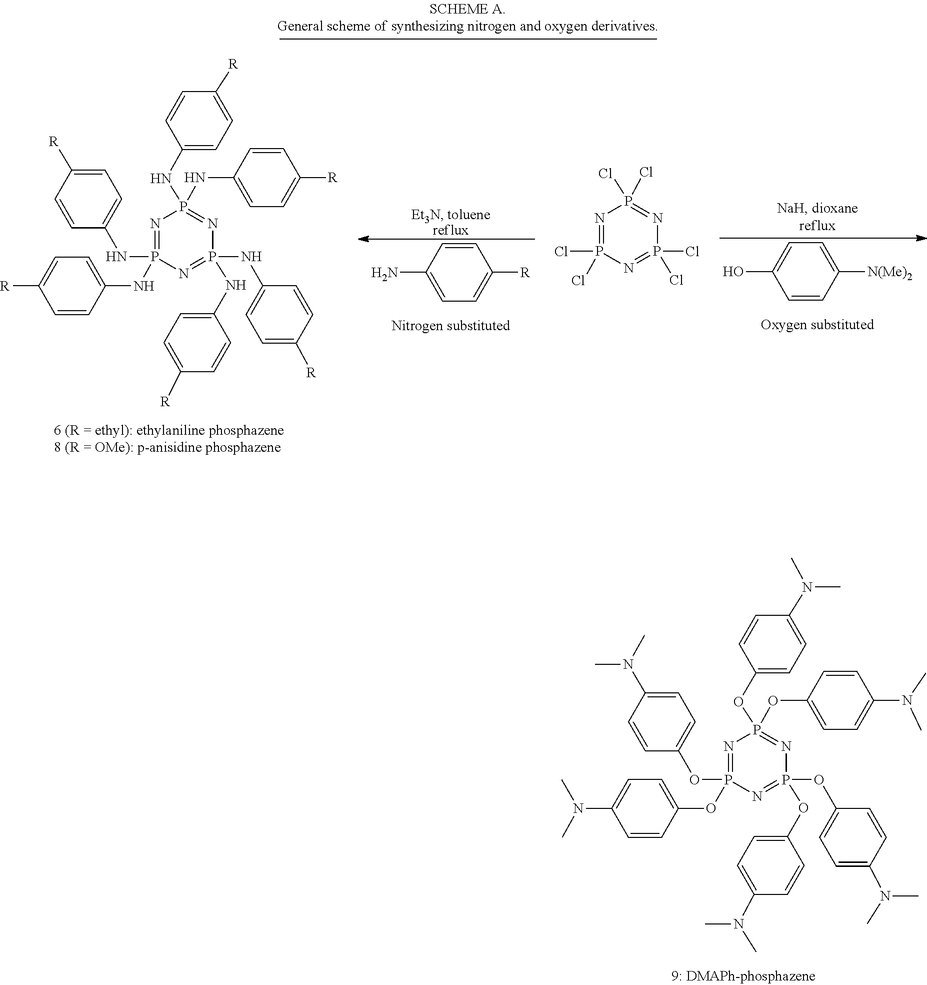

Preparation of Compound 4: Synthesis of Hexa 4-Ethylanilinecyclotriphosphazene (6).

To a stirred solution of hexachlorocyclotriphosphazene (20.0 grams (g), 57.5 mmol) in dry toluene (400 milliliters (mL)) and triethylamine (200 mL, 1430 mmol) was added 4-ethylaniline (85 mL, 681 mmol) at room temperature. The formation of a white precipitate indicated the onset of the reaction. The solution was heated to reflux overnight. After such time, an aliquot was removed for analysis by liquid chromatograph/mass spectrometry (LC/MS), which indicated full conversion to the hexa-substituted product. The mixture was cooled to room temperature and filtered, rinsing the precipitate with ethyl acetate. The solvents were removed under reduced pressure by rotary evaporation. The remaining viscous oil was then distilled to remove the excess triethylamine and aniline. The remaining dark-colored solid was triturated with methanol, filtered, rinsed with methanol, and dried in a vacuum oven to give a white solid (28.4 g, 57% yield).

Preparation of Compound 5: Synthesis of Hexa Anisidylcyclotriphosphazene (8).

To a stirred solution of hexachlorocyclotriphosphazene (10.0 g, 28.7 mmol) in dry toluene (200 mL) and triethylamine (100 mL, 717 mmol) was added para-anisidine (42.5 g, 345 mmol) at room temperature. The formation of a white precipitate indicated the onset of the reaction. The solution was heated to reflux overnight. After such time, an aliquot was removed for analysis by LCMS, which indicated full conversion to the hexa-substituted product. The mixture was cooled to room temperature and filtered, rinsing the precipitate with ethyl acetate. The solvents were removed under reduced pressure by rotary evaporation. The remaining viscous oil was then distilled to remove the excess triethylamine and anisidine. The remaining dark-colored solid was triturated with methanol, filtered, rinsed with methanol, and dried in a vacuum oven to give a white solid (10 g, 40% yield).

Preparation of Compound 6: Synthesis of hexa 4-dimethylaminophenoxycyclotriphosphazene (9).

Dimethylaminophenol was synthesized according to the procedure as disclosed by Seim, K. L. et al. in J. Am. Chem. Soc. 2011, 133, pages 16970-16976, except sodium cyanoborohydride was used instead of sodium borohydride. To a flame dried 500 mL 2 neck flask was added the NaH (12 g, 300 mmol). Under an atmosphere of nitrogen, dioxane (100 mL) was added. The solution was cooled to 0° C. and the 4-dimethylaminophenol (31 g, 226 mmol) was added as a solution in dioxane (50 mL) slowly, portion-wise. The solution turned brown and allowed to stir for 20 min. The hexachlorocyclotriphosphazene (10 g, 28.7 mmol) was added as a solution in dioxane (50 mL) drop-wise by addition funnel. After complete addition, the ice bath was removed and replaced with an oil bath, a condenser was placed on the flask, and the mixture was refluxed (110° C.) overnight. An aliquot was removed for analysis by LCMS, which indicated nearly full conversion to the hexasubstituted product. Saturated ammonium chloride solution was added slowly to quench any remaining NaH. The solution was a dark red/brown color. The mixture was extracted with EtOAc and the combined organic layers were washed with brine, dried (MgSO₄) and concentrated to give a white solid in a pink slurry. The slurry was triturated with MeOH for 30 minutes then filtered via Buchner funnel, washed with cold MeOH, and dried using a vacuum oven to obtain a white solid (14 g, 51% yield).

Shown in Table 3 below is the results for TGA, indicating the temperature where 5% weight loss and 10% weight loss of the various compounds occur.

TABLE 3

| | | Temperature (° C.) | |
|---|---|---|---|
| Compound | Substituent | 5% wt loss | 10% wt loss |
| 1 | —O-4-(methoxy)phenyl | 346 | 365 |
| 2 | —NH-phenyl | 277 | 289 |
| 3 | —NH-cyclohexyl | 181 | 215 |
| 4 | —NH-4-ethylphenyl | 246 | 257 |
| 5 | —NH-4-methoxyphenyl | 247 | 272 |
| 6 | —O-4-(dimethylamino)phenyl | 370 | 393 |

Select compounds where blended the polypropylene, made into a meltblown web, and charged following the Fiber and Non-woven Sample Preparation described above. The QF value of the non-woven web was tested using the Filtration Performance Test Method. The results are shown in Table 4 for samples tested with a face velocity at 13.8 cm/s and those in Table 5 were tested with a face velocity at 6.9 cm/s.

TABLE 4

| | | Wt % Compound | QF value | |
|---|---|---|---|---|
| Sample | Compound | in PP-1 resin | Method H | Method C |
| CE A | None | | 0.30 | 0.14 |
| EX 1 | 4 | 1 | 0.46 | 0.25 |
| EX 2 | 5 | 0.85 | 0.23 | 0.27 |
| EX 3 | 6 | 1 | 0.23 | 0.27 |

TABLE 5

| | | Wt % Compound | QF value | |
|---|---|---|---|---|
| Sample | Compound | in PP-2 resin | Method H | Method C |
| CE B | None | | 0.51 | 0.72 |
| CE C | 1 | 0.2 | 0.42 | 0.59 |
| CE D | 1 | 0.5 | 0.45 | 0.61 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A composition comprising:
A plurality of electrostatically-charge fibers, the electrostatically-charge fibers comprising (a) a thermoplastic resin; and
(b) a charge-enhancing additive comprising a cyclotriphosphazene core substituted with at least three amino-cyclic carbon groups.

2. The composition of claim 1, wherein the amino-cyclic carbon group comprises an amino-cycloalkyl group.

3. The composition of claim 2, wherein the amino-cycloalkyl group comprises a cycloalkyl group comprising 5 to 8 carbon atoms.

4. The composition of claim 1, wherein the amino-cyclic carbon group comprises an amino-aryl group.

5. The composition of claim 4, wherein the amino-aryl group comprises at least one aromatic ring, optionally substituted with at least one of an ether, an amine, and an alkyl group.

6. The composition of claim 4, wherein the amino-aryl group comprises at least one of a phenylamino group, an alkylphenylamino group, an alkoxyphenylamino group, a phosphor amino indane, or an alkylaminophenoxy group.

7. The composition of claim 1, wherein the charge-enhancing additive is of formula I: 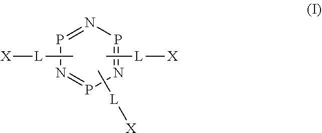
where L is selected from NH or N(R) and R is an alkyl group, optionally comprising at least 1 catenated atom selected from N or O; and wherein X comprises a cyclic carbon group.

8. The composition of claim 1, the charge-enhancing additive is of formula II: 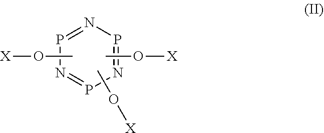
wherein X comprises a cyclic carbon group comprising an amino group.

9. The composition of claim 1, wherein the charge-enhancing additive comprising at least one of:

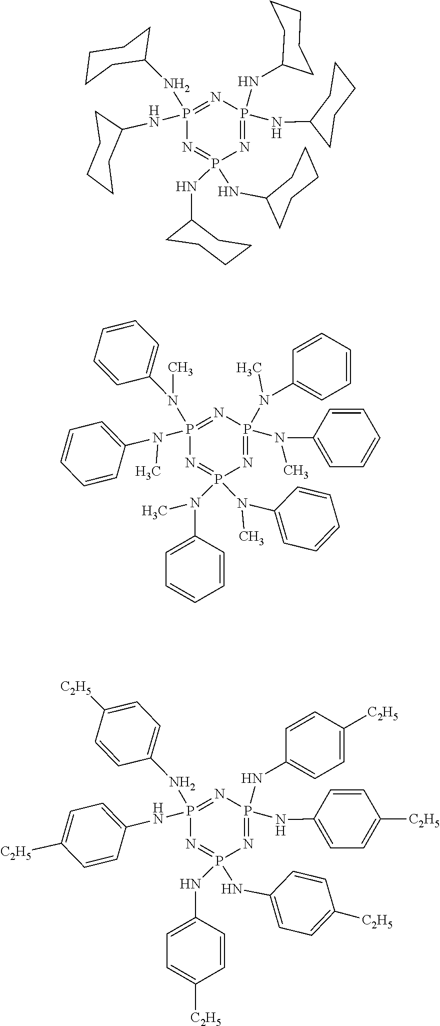

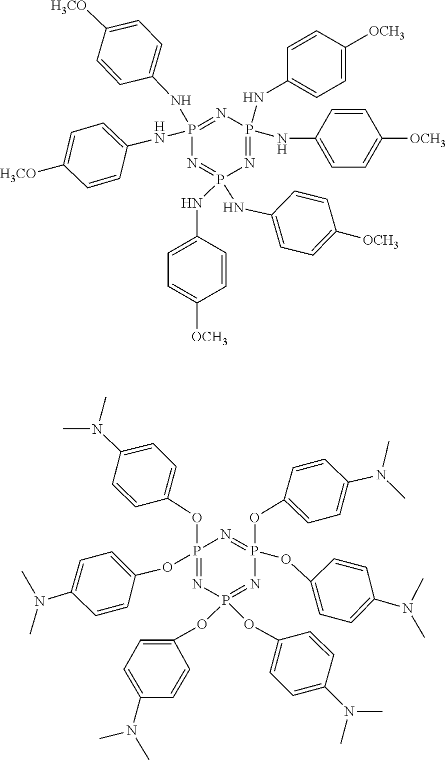

10. The composition of claim 1, wherein the charge-enhancing additive does not decompose at less than 220° C.

11. (canceled)

12. The composition of claim 1, wherein the electrostatically-charged fibers comprise at least 0.01 to at most 5.0% by weight of the charge-enhancing additive.

13. The composition of claim 1, wherein the electrostatically-charged fibers further comprise (c) an additive, the additive comprising at least one of a pigment, a light stabilizer, a primary or secondary antioxidant, a metal deactivator, a hindered amine, a hindered phenol, a fatty acid metal salt, a triester phosphite, a phosphoric acid salt, a fluorine-containing compound, and a nucleating agent.

14. The composition of claim 1, wherein the composition is substantially free of a second charge-enhancing additive, optionally wherein the second charge-enhancing additive is a hindered amine.

15. The composition of claim 1, wherein the composition exhibits a quasi-permanent electric charge.

16. (canceled)

17. (canceled)

18. A nonwoven fibrous web comprising the electrostatically-charged fibers according to claim 1.

19. A medical article comprising the nonwoven fibrous web of claim 18.

20. A filtering article comprising the nonwoven fibrous web of claim 18, optionally wherein the filtering article is a respirator.

21. The filter article of claim 20, wherein the nonwoven fibrous web is pleated.

22. Method of making an electret comprising
providing the composition of claim 1;
charging the composition via corona treatment, hydrocharging, tribocharging, or combinations thereof to form the electret.

23. The use of a cyclotriphosphazene core substituted with at least three amino-cyclic carbon groups as a charge-enhancing additive.
